(19) United States
(12) Patent Application Publication
(10) Pub. No.: US 2010/0273517 A1
(43) Pub. Date: Oct. 28, 2010

(54) METHOD AND APPARATUS FOR COMPONENT TEMPERATURE CONTROL BASED ON REDUCTION OF DATA RATE AND WTRU TRANSMIT POWER

(75) Inventors: Ana Lucia Pinheiro, Phoenixville, PA (US); Matthew G. Puzio, Collegeville, PA (US); Janet A. Stern-Berkowitz, Little Neck, NY (US); Bhupendra A. Borse, Jersey City, NJ (US)

Correspondence Address: VOLPE AND KOENIG, P.C.;DEPT. ICC, UNITED PLAZA, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/604,500

(22) Filed: Oct. 23, 2009

Related U.S. Application Data
(60) Provisional application No. 61/108,335, filed on Oct. 24, 2008.

(51) Int. Cl. H04W 52/04

(52) U.S. Cl. 455/522

(57) ABSTRACT

A method and an apparatus are provided for controlling component temperature in a wireless transmit receive unit (WTRU) and thereby preventing the component from reaching an undesirable temperature. A method and an apparatus are provided for reducing a value of a maximum allowed transmit power to adjust a data rate. The WTRU adjusts the value of the maximum allowed transmit power resulting in an adjustment to the temperature of the component.

### CROSS REFERENCE TO RELATED APPLICATION

This application claims the benefit of a U.S. Provisional Application Ser. No. 61/108,335 filed on Oct. 24, 2008, which is incorporated by reference as if fully set forth.

### FIELD OF INVENTION

This application is related to wireless communications.

### BACKGROUND

In electronic equipment of any kind, usage of the equipment results in the internal components dissipating energy in the form of heat. Without preventive measures, continuous operation may at times cause some of the components to become excessively hot resulting in undesirable effects such as malfunctioning components or, in the case of consumer electronics, making the device too hot to handle. In some cases, the hardware design and component placement alone may be able to prevent the excessive heat situation. For example, in the case of large equipment, heat sinks and properly placed fans with enough cooling power can be used to prevent over-heating of components.

In the case of smaller devices, it may not always be possible to prevent overheating by hardware design and component placement. The smaller devices have many more constraints than large equipment. In smaller devices such as laptops which typically have a fan, placing the heat dissipating components near the fan would likely help or prevent the excessive heat situation; however, it may not always be possible to place the heat dissipating components close enough to the fan or the fan may not be strong enough. In devices such as cell phones, personal digital assistants (PDAs), and other handheld devices where small size is essential, use of the necessary heat sinks and fans to meet the temperature requirements may not be possible at all.

In the case of a wireless communications device such as a cell phone or a laptop, the internal components, especially the transmitter components, may dissipate a lot of heat, especially in the case of high data rate applications. It is expected that best engineering practices are used in the design of the device to attempt to avoid the excessive heat situation. However, since these are devices that will be handled by consumers, it is desirable to ensure that the situation in which the device gets too hot to handle does not occur. A method and apparatus are provided for controlling component temperature in a wireless communication device with a goal of preventing the components from reaching an undesirable temperature.

### SUMMARY

A method and an apparatus are provided for controlling component temperature in a wireless transmit receive unit (WTRU) and thereby preventing the component from reaching an undesirable temperature. A method and an apparatus are provided for reducing a value of a maximum allowed transmit power to adjust a data rate. The WTRU adjusts the value of the maximum allowed transmit power resulting in an adjustment to the temperature of the component.

A method and an apparatus are provided with a processor configured to reduce a maximum allowed transmit power by a predefined value on a condition that a current temperature of the WTRU is greater than a predefined maximum allowed temperature, the processor is configured to set a lower limit on the maximum allowed transmit power, and the processor is further configured to set the maximum allowed transmit power to the lower limit of the maximum allowed transmit power, and to enter a stand-by mode on a condition that the maximum allowed transmit power is less than or equal to the lower limit of the maximum allowed transmit power.

A method and an apparatus includes a processor further configured to set the maximum allowed transmit power to the lower limit of the maximum allowed transmit power, and to begin using a minimum transport format combination (TFC) set on a condition that the maximum allowed transmit power is less than or equal to the lower limit of the maximum allowed transmit power.

### BRIEF DESCRIPTION OF THE DRAWINGS

A more detailed understanding may be had from the following description, given by way of example in conjunction with the accompanying drawings wherein:

FIG. 1 shows an example wireless communication system including a plurality of wireless transmit receive units (WTRUs), a base station, and a radio network controller (RNC);

FIG. 2 is a functional block diagram of a WTRU and the base station of FIG. 1;

FIG. 3 shows an example block diagram of a radio interface protocol model;

FIGS. 4A and 4B are flow diagrams of a procedure for component temperature control in accordance with an embodiment; and

FIGS. 5A and 5B are flow diagrams of a procedure for component temperature control according to another embodiment.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

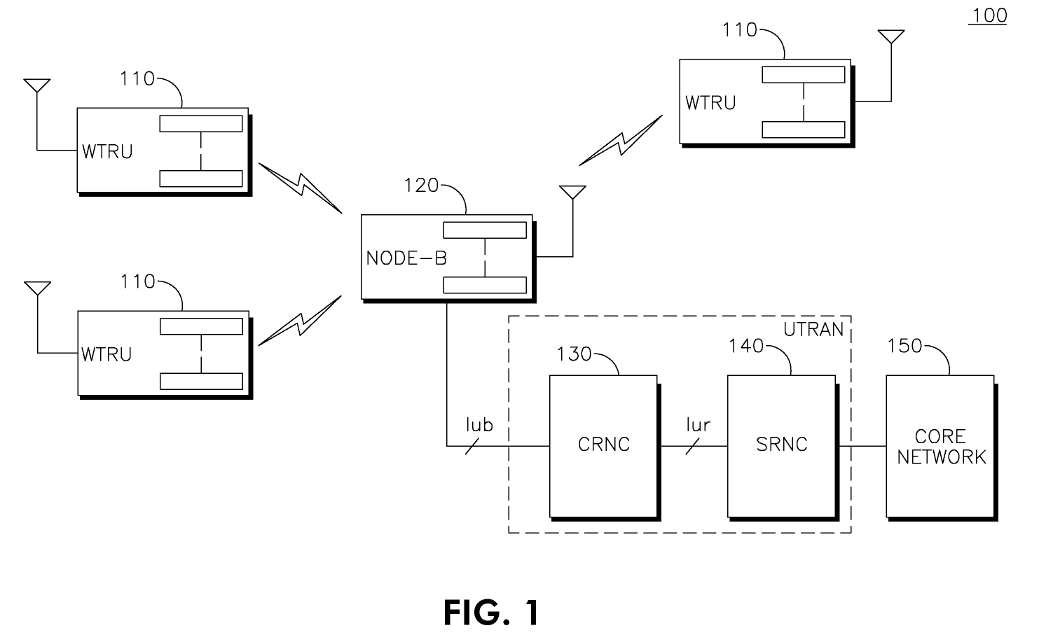

FIG. 1 shows a wireless communication system 100 in which one or more of the disclosed embodiments may be implemented. The wireless communication system 100 may include a plurality of WTRUs 110, a Node-B 120, a controlling radio network controller (CRNC) 130, a serving radio network controller (SRNC) 140, and a core network 150. The CRNC 130 and the SRNC 140 may be part of a Universal Mobile Telecommunications System (UMTS), which may be incorporated into a UMTS Terrestrial Radio Access Network (UTRAN), though it will be appreciated that the wireless communication system 100 may include any type of wireless network suitable for interfacing with one or more of the WTRUs 110. For example, the wireless communication system 100 may include a Global System for Mobile communications (GSM) network, a Long Term Evolution (LTE) network, an LTE-Advanced Network, a Interim Standard 95 (IS-95) network, a CDMA2000 network, a wireless local area network (WLAN) (e.g., an IEEE 802.11 compliant network), a wireless personal area network (WPAN) (e.g., an IEEE 802.15 complaint network), and/or a broadband wireless access network (e.g, an IEEE 802.16 compliant network, such as Worldwide Interoperability for Microwave Access (WiMAX)).

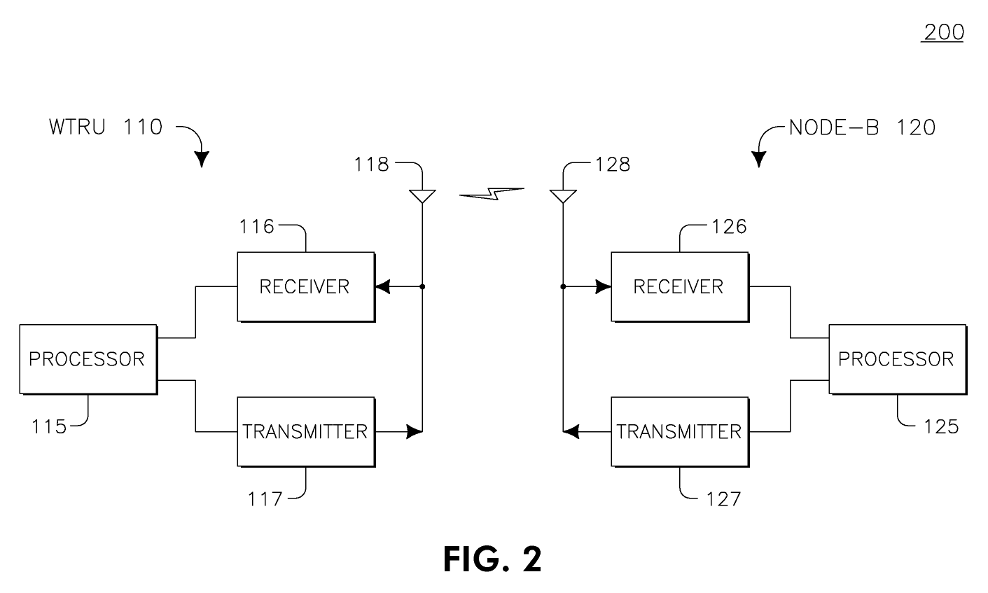

FIG. 2 is a functional block diagram 200 of an WTRU 110 and the Node-B 120 of the wireless communication system 100 of FIG. 1. As shown in FIG. 2, the WTRU 110 is in communication with the Node-B 120. The WTRU 110 is configured to perform a method for controlling component temperature.

In addition to the components that may be found in a typical WTRU, the WTRU 110 includes a processor 115, a receiver 116, a transmitter 117, and one or more antennas 118. The processor 115 is configured to perform a method for controlling component temperature. The receiver 116 and the transmitter 117 are in communication with the processor 115. The antenna(s) 118 is/are in communication with both the receiver 116 and the transmitter 117 to facilitate the transmission and reception of wireless data.

In addition to the components that may be found in a typical base station, the Node-B 120 includes a processor 125, a receiver 126, a transmitter 127, and one or more antennas 128. The receiver 126 and the transmitter 127 are in communication with the processor 125. The antenna(s) 128 is/are in communication with both the receiver 126 and the transmitter 127 to facilitate the transmission and reception of wireless data.

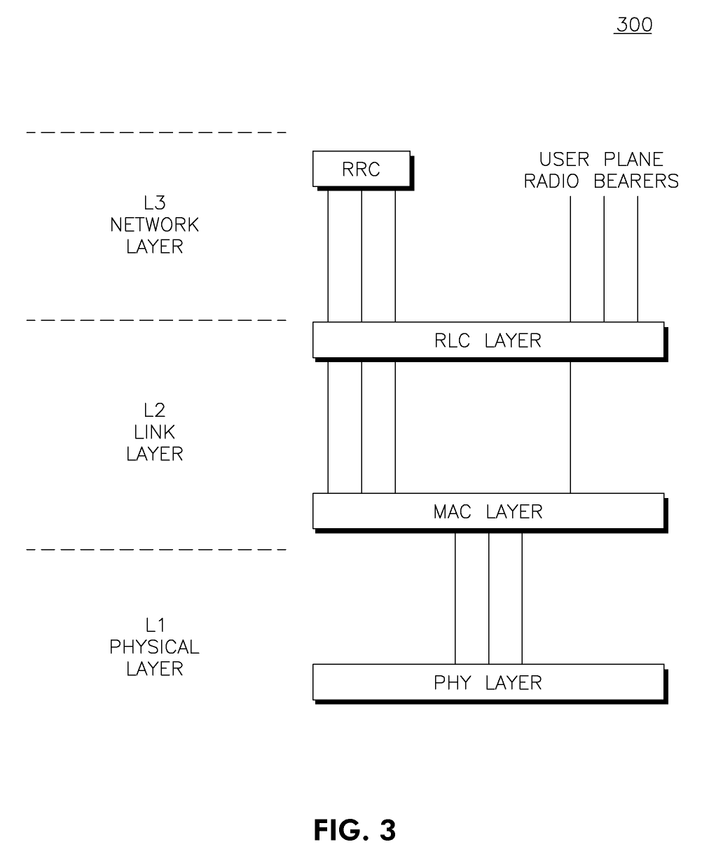

FIG. 3 illustrates radio interface protocol model 300. The WTRU 110 may include a radio resource control (RRC) layer (L3) entity, a radio link control (RLC) layer (L2) entity, a medium access control (MAC) layer (L2) entity, and a physical (PHY) layer (L1) entity. The RLC entity includes a transmitting side subassembly and a receiving side subassembly. The transmitting side subassembly includes a transmission buffer. The RLC entity increases reliability of the radio transmission. The MAC entity controls the device access to the transmission medium. The PHY layer transmits and receives data over the air. The Node-B 120 may include the same entities as shown in FIG. 3.

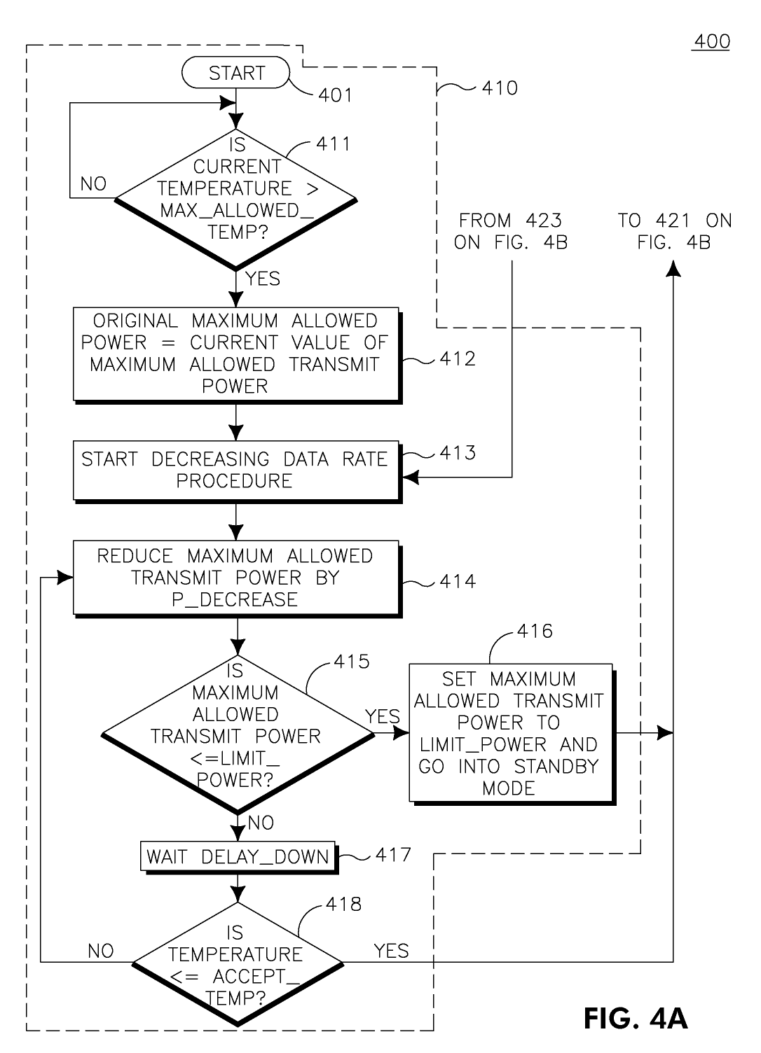

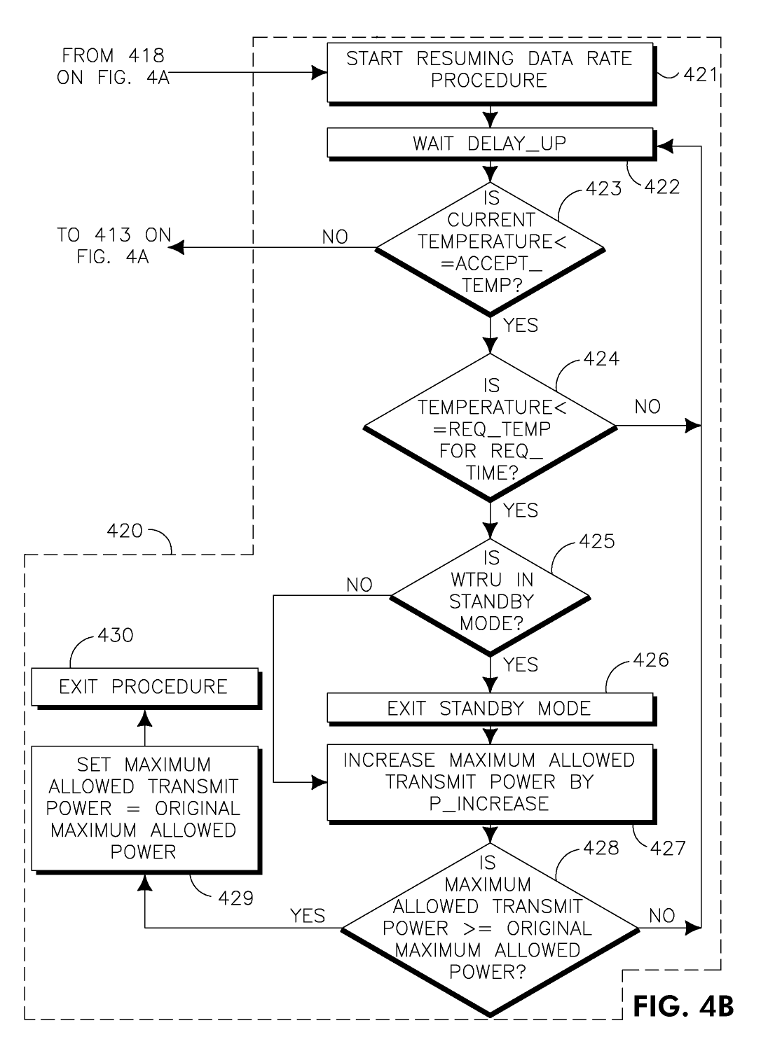

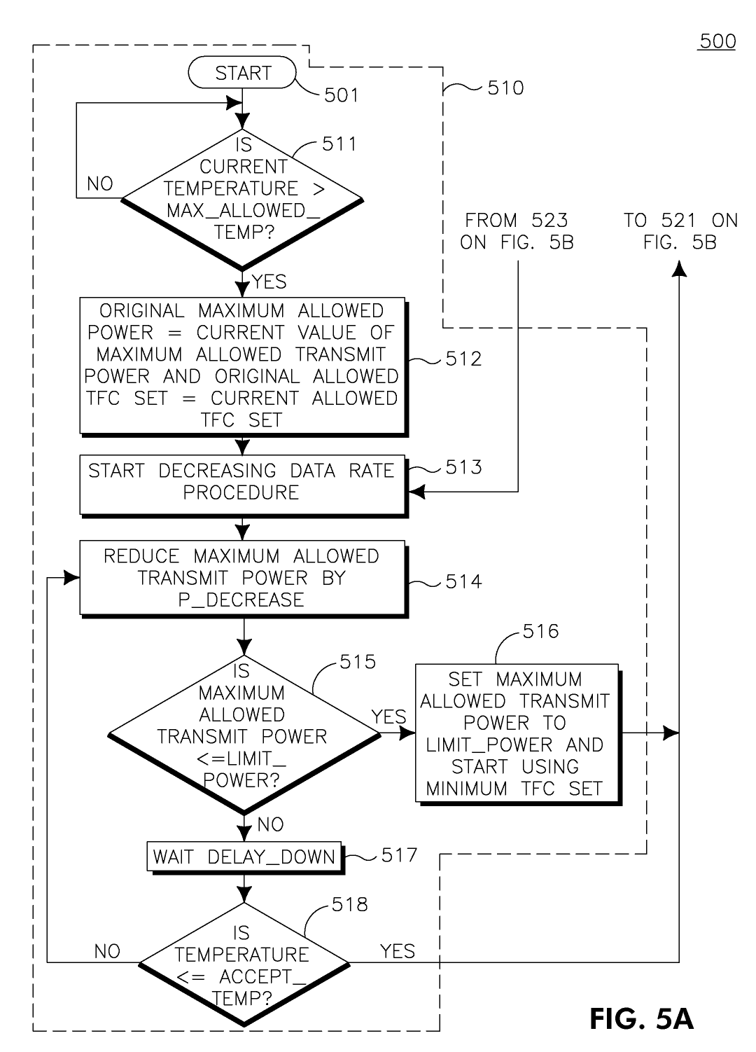

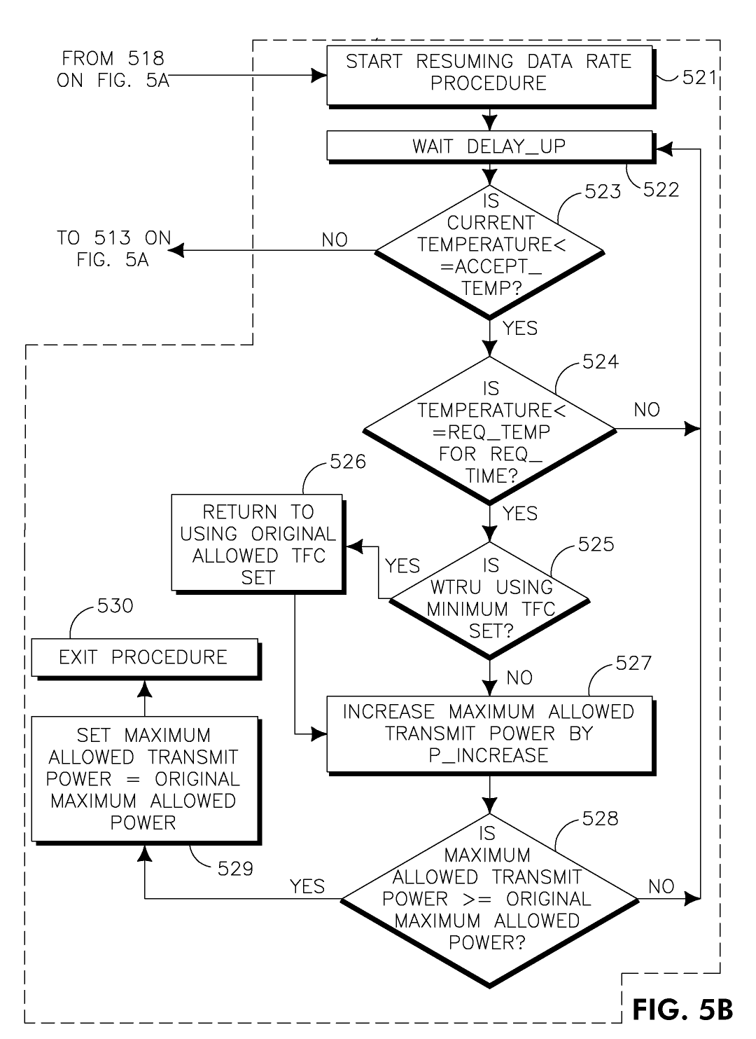

FIGS. 4A, 4B and FIGS. 5A, 5B provide examples for controlling component temperature by adjusting the value of the maximum allowed transmit power. Given an over-temperature condition, the maximum allowed transmit power is reduced in order to reduce temperature and when the condition is cleared, the maximum allowed transmit power is returned to its original value. These examples are based on the principle of adjusting the value of the maximum allowed transmit power to adjust the data rate, which in result adjusts the transmit power, which in result adjusts the temperature.

In third generation partnership project (3GPP) universal mobile telecommunications system (UMTS), the maximum allowed transmit power is used in the TFC and enhanced TFC (E-TFC) selection algorithms in the MAC layer entity. These algorithms include the determination of transport block size and number of transport blocks to transmit, which directly relates to the transmit data rate. The maximum allowed transmit power value in the algorithm is typically one of two values. One of the values is provided by the network to control what the WTRU 110 is permitted to transmit. The other is provided internal to the WTRU 110, and it specifies that which the WTRU 110 is physically able to transmit. The TFC/E-TFC selection algorithms use the minimum of the two values.

FIGS. 4A and 4B are flow diagrams of a procedure 400 for controlling component temperature according to one embodiment. The procedure comprises two parts, 410 and 420. First, the WTRU 110 is configured to decrease the data rate to reach an acceptable temperature level 410, and second, the WTRU 110 is configured to resume the data rate, which means it is configured to allow the data rate to be increased if the temperature is below the required level 420.

Referring to FIG. 4A, the procedure begins 401 when the WTRU 110 exceeds the maximum allowed temperature (i.e., Max_Allowed_Temp) 411, the value of the maximum allowed transmit power is saved 412 before starting the decreasing data rate procedure 413. The current value of maximum allowed transmit power is saved as the original maximum allowed power 412. The WTRU 110 is configured to start decreasing the data rate 413. The Max_Allowed_Temp, typically represented in degrees, is the temperature over which the decreasing data rate procedure is triggered. Alternatively, the temperature may be represented in any unit.

In order to decrease the data rate, the WTRU 110 decreases its maximum allowed transmit power by a step of power (i.e., P_decrease) 414. The power step P_decrease is typically represented in dBs. Alternatively, the power step may be represented in any unit. Alternatively, the WTRU 110 may be configured to decrease its maximum allowed transmit power continuously over time. It is noted that to ensure the maximum allowed transmit power is not exceeded, a WTRU 110 will usually use the maximum allowed transmit power in its determination of how much data it can transmit. A lower maximum allowed transmit power will result in a lower data rate. A lower data rate will subsequently result in a lower actual transmit power and lower temperature. Note that each individual power step decrease may or may not result in a decrease in temperature; more than one step may be required for a decrease in the temperature. For the alternative of continuously decreasing maximum allowed transmit power, decreases over time may be required to achieve decreases in temperature.

The WTRU 110 may be configured to determine whether the maximum allowed transmit power is less than or equal to the lower limit of the maximum allowed transmit power 415. The lower limit (i.e., Limit_Power) of the maximum allowed transmit power is typically represented in dBm. Alternatively, the lower limit of the maximum allowed transmit power may be represented in any unit. If the maximum allowed transmit power is less than or equal to the lower limit of the maximum allowed transmit power, then the WTRU 110 may be configured to set the maximum allowed transmit power to the lower limit of the maximum allowed transmit power and enter the stand-by mode 416. If the maximum allowed transmit power is not less than or equal to the lower limit of the maximum allowed transmit power 415, then the WTRU 110 may be configured to wait for a predefined time (i.e., Delay_Down) 417. After waiting the predefined time, the WTRU 110 may be configured to determine whether the temperature has decreased to an acceptable level (i.e., Accept_Temp) 418 by checking the temperature. Alternatively, the WTRU 110 may be configured to determine whether the temperature has decreased to an Accept_Temp by checking the temperature continuously over time.

The Delay_Down is the time to wait for the temperature to converge after a potential data rate decrease resulting from a decrease in maximum allowed transmit power. The Delay_Down time is typically represented in seconds. Alternatively, the time may be represented in any unit. The Accept_Temp, typically represented in degrees, is the acceptable temperature at which the WTRU 110 may be configured to stop the data rate decrease procedure 410. Alternatively, the temperature may be represented in any unit. The Delay_Down may be greater than or equal to zero. A value of zero means there is no wait time. When the temperature of the WTRU 110 reaches an acceptable level 418, the WTRU 110 may be configured to start the resuming data rate procedure 420. Otherwise, the WTRU 110 may be configured to decrease the maximum allowed transmit power by a step of power (i.e., P_decrease) 414. Alternatively, when the temperature of the WTRU 110 has not reached an Accept_Temp, the WTRU 110 may be configured to continue decreasing its maximum allowed transmit power continuously over time.

The procedure for reducing the maximum allowed transmit power by the step of power P_decrease, or alternatively, continuously over time, is repeated, or alternatively, continued until either the temperature reaches Accept_Temp 418 or the maximum allowed transmit power is too low (i.e., less than or equal to Limit_Power) 415. When the maximum allowed transmit power is too low, the data rate is too low and/or data transmission from the WTRU 110 is too weak to be received by the base station. As a result, the WTRU 110 may be configured to transition to a stand-by mode 416 in which no data is transmitted.

Stand-by mode is defined as a mode in which the WTRU 110 is not transmitting data in a radio access technology (RAT) associated with the temperature control procedure.

In a case that a WTRU 110 is supporting multiple radio access technologies (RATs), such as both WCDMA and WiMAX, each RAT may have its own temperature control procedure as defined in FIGS. 4A and 4B and FIGS. 5A and 5B. Alternatively, there may be one procedure for two or more RATs including the possibility of one procedure for all the RATs supported by the WTRU 110, or only a subset of the RATs supported by the WTRU 110 may have a temperature control procedure.

For the case in which a WTRU 110 is supporting multiple RATs, and if the WTRU 110 enters the stand-by mode based on the temperature control procedure for one RAT, the WTRU 110 is configured to stop transmitting for the one RAT, and the WTRU 110 may be configured to stop transmitting for one or more of the other RATs also.

For the case in which a WTRU 110 is supporting multiple RATs, and if the WTRU 110 enters the stand-by mode based on the temperature control procedure for more than one RAT, the WTRU 110 is configured to stop transmitting for one or more of the RATs associated with the temperature control procedure. The WTRU 110 may be configured to stop transmitting for all the RATs associated with the temperature control procedure. The WTRU 110 may be configured to stop transmitting for one or more of the RATs that are not associated with the temperature control procedure.

Referring to FIG. 4B, when the WTRU 110 reaches an acceptable temperature level or the WTRU 110 is in the stand-by mode due to a decreasing data rate procedure 410 as described above, the WTRU 110 may be configured to resume the data rate 420. The WTRU 110 may be configured to enter the resuming data rate procedure 421. The WTRU 110 may be configured to wait for a predefined time (i.e., Delay_Up) 422. The Delay_Up is the time, typically represented in seconds, to wait for the temperature to converge after a potential data rate increase resulting from an increase in maximum allowed transmit power. It is also the time to wait for the temperature to converge upon entry into the resuming data rate procedure after leaving the decreasing data rate procedure. Alternatively, the time may be represented in any unit. The Delay_Up may be any value greater than or equal to zero. A value of zero means that there is no wait.

After waiting the predefined time, the WTRU 110 may be configured to determine whether the current temperature is less than or equal to the acceptable level 423 by checking the temperature. If the WTRU 110 determines that the temperature is not at the acceptable level 423, then the WTRU 110 may be configured to further reduce the data rate 413 by returning to the decreasing data rate procedure 410.

If the temperature is at or below the Accept_Temp 423, then the WTRU 110 may be further configured to determine whether the temperature has remained at or below a required level (i.e., Req_Temp), for a predefined period of time (i.e., Req_Time) 424. The Req_Time, typically represented in degrees, is the required temperature the WTRU 110 must be at or below for Req_Time before the WTRU 110 starts increasing power again. Alternatively, the temperature may be represented in any unit. The Req_Time is the time, typically in seconds, which the WTRU 110 must be at or below the Req_Temp, before the WTRU 110 starts increasing the maximum allowed transmit power. Alternatively, the time may be represented in any unit.

If the WTRU 110 has remained at or below the Req_Temp for the Req_Time 424, and the WTRU 110 is not in stand-by mode 425, then the WTRU 110 may be configured to increase the maximum allowed transmit power by P_increase 427. Alternatively, the WTRU 110 may be configured to increase the maximum allowed transmit power continuously over time. The WTRU 110 may be configured to determine whether the maximum allowed transmit power is greater than or equal to the original maximum allowed power 428. If the maximum allowed transmit power is greater than or equal to the original maximum allowed power 428, then the maximum allowed transmit power is set to the original maximum allowed power 429 (i.e., the maximum allowed transmit power when the decreasing data rate procedure 410 was first started). The resuming data rate procedure 420 exits procedure 430. If the maximum allowed transmit power is not greater than or equal to the original maximum allowed power 428, then the WTRU 110 may be configured to wait Delay_Up time 422 and continue the resuming data rate procedure 420.

If the WTRU 110 has remained at or below the Req_Temp for the Req_Time 424, and the WTRU 110 is in stand-by mode 425, then the WTRU 110 may be configured to exit the stand-by mode 426, and the data transmission may resume. The WTRU 110 may be configured to increase the maximum allowed transmit power by P_increase 427. Alternatively, the WTRU 110 may be configured to increase the maximum allowed transmit power continuously over time. The WTRU 110 may be configured to determine whether the maximum allowed transmit power is greater than or equal to the original maximum allowed power 428. If the maximum allowed transmit power is greater than or equal to the original maximum allowed power 428, then the maximum allowed transmit power is set equal to the original maximum allowed power 429. The resume data rate procedure 420 exits the procedure 430. If the maximum allowed transmit power is not greater than or equal to the original maximum allowed power 428, then the WTRU 110 may be configured to wait Delay_Up time 422 and continue the resuming data rate procedure 420.

If the WTRU 110 has not remained at or below the Req_Temp for the Req_Time 424, then the WTRU 110 may be configured to wait Delay_Up time 422 and continue the resuming data rate procedure 420.

When the resuming data rate procedure exits 430, the WTRU 110 may be configured to automatically restart procedure 410 starting at element 401, as illustrated in FIG. 4A. Alternatively, the WTRU 110 may be configured to restart procedure 410 after waiting a predefined fixed amount of time or periodically, or in response to a triggering event.

The P_increase may be the same as the P_decrease. The Accept_Temp and the Req_Temp may be less than the Max_Allowed_Temp. Optionally, the values of the P_increase and the P_decrease may change dynamically, based on how the WTRU 110 reacts in terms of temperature increases or temperature decreases. The Accept_Temp may be the same or different from the Req_Temp. In a case that the Accept_Temp is set to a temperature greater than the Req_Temp, the result will likely be more time waited before increasing the maximum allowed transmit power thereby reducing the possibility of ping-ponging between the decreasing data rate procedure and the increasing data rate procedure. For the case where Accept_Temp and Req_Temp are the same, element 423 is skipped and element 424 is changed such that if the WTRU 110 has not remained at or below the Req_Temp for the Req_Time 424, then the WTRU 110 may be configured to restart the decreasing data rate procedure 413 instead of waiting Delay_Up 422.

FIGS. 5A and 5B are flow diagrams of a procedure 500 for component temperature control in accordance with another embodiment. Similar to the FIGS. 4A and 4B, the procedure in FIGS. 5A and 5B comprises two parts. First, in FIG. 5A, the WTRU 110 may be configured to decrease its data rate to reach an acceptable temperature level 510, and second, as shown in FIG. 5B, the WTRU 110 may be configured to resume the data rate, which means it may be configured to allow the data rate to be increased if the temperature is below the required level 520. The WTRU 110 may be configured to reduce the allowed TFC set to a minimum TFC set when the maximum allowed power is reduced to its allowed minimum. An example of a minimum TFC set is the minimum set of TFCs defined in the 3GPP standard specification. Another example, for the case of high speed uplink packet access (HSUPA), is the enhanced dedicated channel (E-DCH) minimum set E-TFCI defined in the 3GPP standard specification. Setting the allowed TFC set to a minimum set reduces data transmission to a minimum rather than shutting data transmission off completely as is the case in stand-by mode.

Referring to FIG. 5A, the procedure begins 501 when the WTRU 110 exceeds the maximum allowed temperature (i.e., Max_Allowed_Temp) 511. The value of the maximum allowed transmit power and the current allowed TFC set are saved 512 before starting the decreasing data rate procedure 513. The current value of maximum allowed transmit power is saved as the original maximum allowed power and the current allowed TFC set is saved as the original allowed TFC set 512. The WTRU 110 may be configured to start decreasing its data rate 513. The WTRU 110 reduces its maximum allowed transmit power by a step of power decrease (i.e., P_decrease) 514. Alternatively, the WTRU 110 may be configured to decrease its maximum allowed transmit power continuously over time. For the alternative of continuously decreasing maximum allowed transmit power, decreases over time may be required to achieve decreases in temperature.

The WTRU 110 may be configured to determine whether the maximum allowed transmit power is less than or equal to the lower limit of the maximum allowed transmit power (i.e., Limit_Power) 515. The Limit_Power of the maximum allowed transmit power is typically represented in dBm. Alternatively, the lower limit of the maximum allowed transmit power may be represented in any unit. If the maximum allowed transmit power is less than or equal to the lower limit of the maximum allowed transmit power, then the WTRU 110 may be configured to set the maximum allowed transmit power to the lower limit of the maximum allowed transmit power and the WTRU 110 may be configured to start using the minimum TFC set 516. If the maximum allowed transmit power is not less than or equal to the lower limit of the maximum allowed transmit power 515, then the WTRU 110 may be configured to wait for a predefined time (i.e., Delay_Down) 517. The Delay_Down may be greater than or equal to zero. A value of zero means there is no wait time. After waiting the predefined time, the WTRU 110 may be configured to determine whether the temperature has decreased to an acceptable level (i.e., Accept_Temp) 518 by checking the temperature. Alternatively, the WTRU 110 may be configured to determine whether the temperature has decreased to an Accept_Temp by checking the temperature continuously over time.

When the WTRU 110 temperature reaches an Accept_Temp at 518, the WTRU 110 may be configured to start the resuming data rate procedure 520 as illustrated in FIG. 5B. Otherwise, the WTRU 110 may be configured to decrease the maximum allowed transmit power by a step of power (P_decrease) 514. Alternatively, when the temperature of the WTRU 110 has not reached an acceptable temperature, the WTRU 110 may be configured to continue decreasing its maximum allowed transmit power continuously over time.

The procedure for reducing the maximum allowed transmit power by the step of power P_decrease, or alternatively, continuously over time, is repeated, or alternatively, continued, until either the temperature reaches the Accept_Temp 518 or the maximum allowed transmit power is too low (i.e., it is below the minimum allowed transmit power, Limit_Power) 515.

Referring to the FIG. 5B, when the WTRU 110 reaches an acceptable temperature level 518 or the WTRU 110 has started using the minimum TFC set 516, the WTRU 110 may be configured to start the resuming data rate procedure 521. The WTRU 110 may be configured to wait for a predefined time (i.e., Delay_Up) 522. The Delay_Up may be any value greater than or equal to zero. A value of zero means that there is no wait. After waiting the predefined time, the WTRU 110 may be configured to determine whether the current temperature is less than or equal to the Accept_Temp 523.

If the temperature is at or below the Accept_Temp 523, then the WTRU 110 may be further configured to determine whether the temperature has remained at or below Req_Temp for Req_Time 524. If the WTRU 110 has remained at or below the Req_Temp for the Req_Time 524, and the WTRU 110 is not using the minimum TFC set 525, then the WTRU 110 may be configured to increase the maximum allowed transmit power by P_increase 527. Alternatively, the WTRU 110 may be configured to increase the maximum allowed transmit power continuously over time. The WTRU 110 may be configured to determine whether the maximum allowed transmit power is greater than or equal to the original maximum allowed power 528. If the maximum allowed transmit power is greater than or equal to the original maximum allowed power 528, then the maximum allowed transmit power is set to the original maximum allowed power 529 (i.e., the maximum allowed transmit power when the decreasing data rate procedure 510 was first started). The resuming data rate procedure 520 exits the procedure 530. If the maximum allowed transmit power is not greater than or equal to the original maximum allowed power 528, then the WTRU 110 may be configured to wait Delay_Up time 522 and continue the resuming data rate procedure 520.

If the WTRU 110 has remained at or below the Req_Temp for the Req_Time 524, and the WTRU 110 is using the minimum TFC set 525, then the WTRU 110 may be configured to return to using the original allowed TFC set 526 (i.e., the allowed TFC set when the decreasing data rate procedure 510 was first started). The WTRU 110 may be configured to increase the maximum allowed transmit power by P_increase 527. Alternatively, the WTRU 110 may be configured to increase the maximum allowed transmit power continuously over time. The WTRU 110 may be configured to determine whether the maximum allowed transmit power is greater than or equal to the original maximum allowed power 528. If the maximum allowed transmit power is greater than or equal to the original maximum allowed power 528, then the maximum allowed transmit power is set equal to the original maximum allowed power 529. The resume data rate procedure 520 exists the procedure 530. If the maximum allowed transmit power is not greater than or equal to the original maximum allowed power 528, then the WTRU 110 may be configured to wait Delay_Up time 522 and continue the resuming data rate procedure 520.

If the WTRU 110 has not remained at or below the Req_Temp for the Req_Time 524, then the WTRU 110 may be configured to wait Delay_Up time 522 and continue the resuming data rate procedure 520.

When the resuming data rate procedure exits 530, the WTRU 110 may be configured to automatically restart procedure 510 starting at the start element 501. Alternatively, the WTRU 110 may be configured to restart the procedure 510 after waiting for a predefined fixed amount of time or periodically, or in response to a triggering event.

The P_increase may be the same as the P_decrease. The Accept_Temp and the Req_Temp may be less than the Max_Allowed_Temp. Optionally, the values of the P_increase and the P_decrease may change dynamically, based on how the WTRU 110 reacts in terms of temperature increases or temperature decreases. The Accept_Temp may be the same or different from the Req_Temp. There is, however, a benefit to setting the Accept_Temp to a temperature greater than the Req_Temp in that the result will likely be more time waited before increasing the maximum allowed transmit power thereby reducing the possibility of ping-ponging between the decreasing data rate procedure and the increasing data rate procedure. For the case where Accept_Temp and Req_Temp are the same, element 523 may be skipped and element 524 changed such that if the WTRU 110 has not remained at or below the Req_Temp for the Req_Time 524, then the WTRU 110 may be configured to restart the decreasing data rate procedure 513 instead of waiting Delay_Up 522.

Note that if during the execution of these procedures such as the ones in FIGS. 4A, 4B and FIGS. 5A, 5B the network provides the WTRU 110 with updated values for maximum allowed transmit power and/or allowed TFC set, the saved original values may be updated as needed to account for these changes and then used in the resuming data rate procedure when restoring the values to their original state.

In another embodiment, the WTRU 110 and a Node-B 120 are configured to downgrade to lower performing channels, such as lower data rate channels for the purpose of reducing transmit power which is expected to reduce temperature. An example of this would be to downgrade from the 3GPP HSUPA channels to the 3GPP Release 99 channels. The WTRU 110 and the Node-B 120 may also be configured to enable upgrade back to higher performing channels, such as higher data rate channels, when the over-temperature condition is resolved. An example of this is to enable upgrade to the 3GPP HSUPA channels from the 3GPP Release 99 channels. In the case of returning to higher performing channels, the actual use of the higher performing channels is based on many factors, so the upgrade would be enabled, but might not be immediately realized. An example method for the WTRU 110 to communicate its ability to use different channel types to a Node-B 120 is to use a capabilities message.

The WTRU 110 may be configured to transmit WTRU capabilities message while remaining connected to the Node-B 120 to signal a change in its capabilities. The Node-B 120 may be configured to adopt these changes based on the received signal from the WTRU 110. A capabilities message is any message or signal that conveys WTRU 110 capabilities. An example capabilities message is the 3GPP WTRU capabilities information message which contains, along with other information, information on the data rates supported by the WTRU 110 and whether or not the WTRU 110 supports HSUPA. In one example of this embodiment, when the temperature of the WTRU 110 exceeds a predefined threshold for a predefined time, the high-speed channel capable WTRU 110 transmits a capabilities message to the Node-B 120 indicating that it does not support high data rate channels (e.g., the 3GPP HSUPA channels). When the over-temperature condition has cleared, the WTRU 110 transmits another capabilities message indicating it does support the high data rate channels.

In another embodiment the WTRU 110 may be configured to force a handover to a radio access technology (RAT) requiring less transmit power and/or lower data rates, such as a handover from a UMTS frequency division duplex (FDD) cell to a global system for mobile communication (GSM) cell. The WTRU 110 may be configured to detect the alternate RAT cells (e.g., GSM cells), measure the cell signals, and report the cell measurements to the Node-B 120. The WTRU 110 may be configured to reduce the values of the measurements reported. The WTRU 110 may reduce the values of the measurements it reports for the serving cell and neighbor cells on the same RAT as the serving cell. In result, the Node-B 120 would find the alternate RAT cells as the better cells and may signal the WTRU 110 to handover to one of those cells. In one example, when the temperature of the WTRU 110 exceeds a predefined threshold for a predefined time, the WTRU 110 may attempt to force a handover from a UMTS cell to a GSM cell in the manner described.

In another embodiment, the WTRU 110, which supports receive diversity, may be configured to disable receive diversity for the purpose of reducing device temperature. This embodiment reduces power consumption when high speed downlink packet access (HSDPA) is active. A reduction in power consumption is likely to result in reduction in device temperature. In one example, when the temperature of the WTRU 110 exceeds a predefined threshold for a predefined time, the WTRU 110 disables the circuitry and processing related to the non-primary antenna. When the over temperature condition is cleared, the WTRU 110 re-enables the circuitry and processing related to the non-primary antenna.

In another embodiment, the WTRU 110 may be configured to reduce the maximum allowed radio frequency (RF) transmit power. This is different from the maximum allowed transmit power which is used to control the data rate, instead it is the actual physical transmit power. One way to reduce the maximum allowed radio frequency (RF) transmit power is to clip the power at the maximum. Alternatively, scale the output power, or the individual components that are summed to achieve the final output power, such that the output power does not exceed the desired reduced value. In one example, when the temperature of the WTRU 110 exceeds a predefined threshold for a predefined time, the WTRU 110 may be configured to reduce its maximum allowed RF transmit power by clipping or scaling. When the over temperature condition is cleared, the WTRU 110 removes the power reduction by removing the clipping or scaling.

It will be appreciated to one skilled in the art that a temperature control may also be applied to other embodiments.

In 802.xx, a WTRU contains an internal data rate control algorithm, which adapts to the channel conditions. Temperature conditions can be added to such algorithms to cause the WTRU 110 to take temperature into account when determining data rate. In one example, after taking channel conditions into account, WTRU 110 reduces the data rate if the temperature has exceeded a predefined threshold for a predefined time. Data rate is reduced until the temperature is acceptable. Subsequently, the data rate can be increased based on what temperature conditions permit with the maximum data rate equal to the rate determined based on channel conditions only.

In general packet radio service (GPRS)/enhanced data rate for global evolution (EDGE), in order to decrease the temperature, the WTRU may be configured to reduce the modulation and coding scheme (MCS) being used, thus reducing the required transmit power. Optionally, the WTRU reduces the number of timeslots being used. The timeslot allocation is performed by the network via the uplink state flag (USF) in the downlink radio block. The WTRU has an internal rule in the RLC/MAC layer to ignore predetermined timeslot allocations if the temperature reaches a predefined threshold. In general packet radio service (GPRS)/enhanced data rate for global evolution (EDGE), the modulation and coding scheme (MCS) being used impacts the required transmit power which impacts the temperature. Temperature conditions can be added to the decision making process for choosing MCS. The WTRU can be configured to reduce the MCS to reduce temperature based on over-temperature conditions and to return the MCS to a value not based on temperature when the temperature conditions are acceptable.

In GPRS/EDGE, the number of timeslots used impacts the required power and therefore the temperature. The timeslot allocation is performed by the network and provided to the WTRU via the uplink state flag (USF) in the downlink radio block. The WTRU may use at most the timeslots allocated by the network, but is not required to use them all. Optionally, the WTRU determines the number of timeslots to use taking into account the temperature conditions. The WTRU can be configured to reduce the maximum number of timeslots to use based on over-temperature conditions such as the temperature exceeding a predefined threshold. The WTRU can also be configured to return the maximum number of timeslots to use to the network provided value when the temperature conditions are acceptable.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

What is claimed is:

1. A wireless transmit receive unit (WTRU) comprising:
a processor configured to reduce a maximum allowed transmit power parameter by a predefined value on a condition that a current temperature of the WTRU is greater than a maximum allowed temperature.

2. The WTRU as in claim 1, further comprising:
the processor configured to enter a stand-by mode on a condition that the maximum allowed transmit power parameter is less than or equal to a lower limit of the maximum allowed transmit power.

3. The WTRU as in claim 1, further comprising:
the processor configured to set the maximum allowed transmit power parameter to a lower limit of the maximum allowed transmit power on a condition that the maximum allowed transmit power parameter is less than or equal to a lower limit of the maximum allowed transmit power.

4. The WTRU as in claim 1 wherein the processor is further configured to decrease a data rate on a condition that the current temperature of the WTRU is greater than the maximum allowed temperature.

5. The WTRU as in claim 1, further comprising:
on a condition that the maximum allowed transmit power parameter is not less than or equal to a lower limit of the maximum allowed transmit power, the processor is further configured to determine whether the current temperature of the WTRU is less than or equal to an acceptable temperature.

6. The WTRU as in claim 5, further comprising:
the processor is further configured to reduce the maximum allowed transmit power parameter by the predefined value on a condition that the current temperature of the WTRU is not less than or equal to the acceptable temperature.

7. The WTRU as in claim 2, further comprising:
on a condition that the current temperature of the WTRU is less than or equal to a predefined required temperature for a predefined required time, the processor further configured to exit the stand-by mode, and increase the maximum allowed transmit power parameter by a value.

8. The WTRU as in claim 1, further comprising:
the processor configured to use the minimum transport format combination (TFC) set on a condition that the maximum allowed transmit power parameter is less than or equal to a lower limit of the maximum allowed transmit power.

9. The WTRU as in claim 8, further comprising:
on a condition that the current temperature of the WTRU is less than or equal to a predefined required temperature for a predefined required time, the processor further configured to return to using an original allowed TFC set, and increase the maximum allowed transmit power parameter by a value.

10. A method implemented in a wireless transmit receive unit (WTRU), the method comprising:
reducing a maximum allowed transmit power parameter by a predefined value on a condition that a current temperature of the WTRU is greater than a maximum allowed temperature.

11. The method as in claim 10, further comprising:
entering a stand-by mode on a condition that the maximum allowed transmit power parameter is less than or equal to a lower limit of the maximum allowed transmit power.

12. The method as in claim 10, further comprising:
setting the maximum allowed transmit power parameter to a lower limit of the maximum allowed transmit power, on a condition that the maximum allowed transmit power parameter is less than or equal to the lower limit of the maximum allowed transmit power.

13. The method as in claim 10 wherein on a condition that the current temperature of the WTRU is greater than the maximum allowed temperature, decreasing a data rate.

14. The method as in claim 10, further comprising:
on a condition that the maximum allowed transmit power parameter is not less than or equal to a lower limit of the maximum allowed transmit power, determining whether the current temperature of the WTRU is less than or equal to an acceptable temperature.

15. The method as in claim 14, further comprising:
reducing the maximum allowed transmit power parameter by the predefined value on a condition that the current temperature of the WTRU is not less than or equal to the acceptable temperature.

16. The method as in claim 11, further comprising:
on a condition that the current temperature of the WTRU is less than or equal to a predefined required temperature for a predefined required time, exiting the stand-by mode; and increasing the maximum allowed transmit power parameter by a value.
